(19) United States
(12) Patent Application Publication
(10) Pub. No.: US 2020/0333860 A1
(43) Pub. Date: Oct. 22, 2020

(54) Information Handling System with Articulated Duct Component and Method Therefor

(71) Applicant: DELL PRODUCTS, LP, Round Rock, TX (US)

(72) Inventors: Mark Ma, Shanghai (CN); Eric M Tunks, Austin, TX (US)

(21) Appl. No.: 16/388,096

(22) Filed: Apr. 18, 2019

(51) Int. Cl. G06F 1/20; G05B 15/02

(52) U.S. Cl. CPC G06F 1/206; G05B 15/02

(57) ABSTRACT

An information handling system includes a fan to generate airflow within the system, and an articulated duct component to modify the airflow. The information handling system further includes a baseboard management controller to selectively adjust an orientation of the articulated duct component based on operational parameters received at the controller.

### FIELD OF THE DISCLOSURE

This disclosure relates generally to information handling systems, and more particularly relates to an adjustable duct component at an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems. Information handling systems can include means for exhausting heat generated during operation.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the present disclosure;

FIG. 2 is a block diagram illustrating an information handling system according to another embodiment of the present disclosure;

FIG. 3 is a block diagram illustrating operation of an articulated duct component according to a specific embodiment of the present disclosure;

FIGS. 4a and 4b are block diagrams illustrating operation of articulated duct components according to another embodiment of the present disclosure;

FIG. 5 is a block diagram illustrating an articulated duct component coupled to a fixed air duct according to a specific embodiment of the present disclosure;

FIG. 6 is a block diagram illustrating multiple articulated duct components arranged to provide a louver according to a specific embodiment of the present disclosure;

FIG. 7 is a flow diagram illustrating a method for controlling an articulated duct component according to a specific embodiment of the present disclosure; and

FIG. 8 is a flow diagram illustrating a method for controlling an articulated duct component according to another embodiment of the present disclosure.

The use of the same reference symbols in different drawings indicates similar or identical items.

### SUMMARY

An information handling system may include a fan to generate airflow within the system, and an articulated duct component to modify the airflow. The information handling system may further include a baseboard management controller to selectively adjust an orientation of the articulated duct component based on operational parameters received at the controller.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

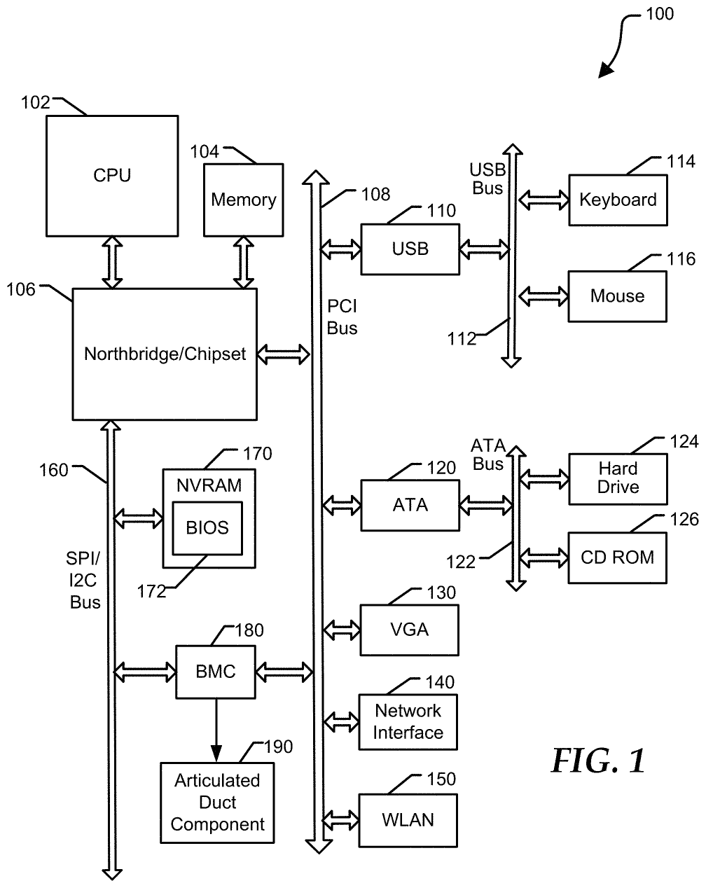

An information handling system can include components that generate heat during operation. The generated heat should be dissipated to ensure optimal performance and reliability of the system. An information handling system typically includes one or more cooling fans that draw in cool air from the environment and exhaust warm air, having extracted heat from the heat-generating components within the system. Heat generation can change dynamically based on the nature of the computational workload performed by the information handling system. For example, one program task may increase heat generation at a graphics processing unit while another task may increase heat generation at a central processing unit, a memory device, an add-on card, and the like. Furthermore, airflow provided by the cooling fans is highly dependent on the number and placement of components included at the information handling system. An information handling system typically includes a baseboard management controller or similar device that is configured to monitor operating parameters and regulate the operating speed of the cooling fans. FIGS. 1-8 illustrate techniques for improving the efficiency of the cooling system.

FIG. 1 illustrates an information handling system 100 including a processor 102, memory devices 104, a platform controller hub (PCH)/chipset 106, a PCI bus 108, a universal serial bus (USB) controller 110, a USB 112, a keyboard device controller 114, a mouse device controller 116, an ATA bus controller 120, an ATA bus 122, a hard drive device controller 124, a compact disk read only memory (CD ROM) device controller 126, a video graphics array (VGA) device controller 130, a network interface controller (NIC) 140, a wireless local area network (WLAN) controller 150, a serial peripheral interface (SPI) bus 160, a NVRAM 170, a baseboard management controller (BMC) 180, and an articulated duct component (ADC) 190. NVRAM 170 can store a basic input/output system (BIOS) 172.

Information handling system 100 can include additional components and additional busses, not shown for clarity. For example, system 100 can include multiple processor cores, audio devices, and the like. While a particular arrangement of bus technologies and interconnections is illustrated for the purpose of example, one of skill will appreciate that the techniques disclosed herein are applicable to other system architectures. System 100 can include multiple CPUs and redundant bus controllers. One or more components can be integrated together. For example, portions of PCH 106 can be integrated within CPU 102. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as CPU 102, a programmable logic array (PLA), an embedded device such as a System-on-a-Chip (SoC), or other control logic hardware. Information handling system 100 can also include one or more computer-readable medium for storing machine-executable code, such as software or data.

BMC 180 can be configured to provide out-of-band access to devices at information handling system 100. As used herein, out-of-band access refers to operations performed independent of an operating system executing at system 100, including operations performed prior to execution of BIOS 172 by processor 102 to initialize operation of system 100. BMC 180 can provide a network interface, a graphical user interface (GUI) and an application programming interfaces (API) to support remote management of system 100. In an embodiment, BMC 180 can include one or more proprietary or standardized bus interfaces, for example USB, I2C, PCI, and the like. As disclosed herein, BMC 180 provides thermal management functions, including monitoring thermal sensors included at one or more system components, regulation of cooling fans, and control of one or more ADCs 190 to steer airflow within system 100 to improve cooling performance.

BIOS 172 can be referred to as a firmware image, and the term BIOS is herein used interchangeably with the term firmware image, or simply firmware. BIOS 172 includes instructions executable by CPU 102 to initialize and test the hardware components of system 100, and to load a boot loader or an operating system (OS) from a mass storage device. BIOS 172 additionally provides an abstraction layer for the hardware, i.e. a consistent way for application programs and operating systems to interact with the keyboard, display, and other input/output devices. When power is first applied to information handling system 100, the system begins a sequence of initialization procedures. During the initialization sequence, also referred to as a boot sequence, components of system 100 are configured and enabled for operation, and device drivers can be installed. Device drivers provide an interface through which other components of the system 100 can communicate with a corresponding device.

In an embodiment, the BIOS 172 can be substantially compliant with one or more revisions of the UEFI specification. The UEFI standard replaces the antiquated personal computer BIOS system found in some older information handling systems. However, the term BIOS is often still used to refer to the system firmware. The UEFI specification provides standard interfaces and interoperability guidelines for devices that together make up an information handling system. In particular, the UEFI specification provides a standardized architecture and data structures to manage initialization and configuration of devices, booting of platform resources, and passing of control to the operating system. The UEFI specification allows for the extension of platform firmware by loading UEFI driver and UEFI application images. For example, an original equipment manufacturer can include customized or proprietary images to provide enhanced control and management of the information handling system 100, including support of the techniques described below.

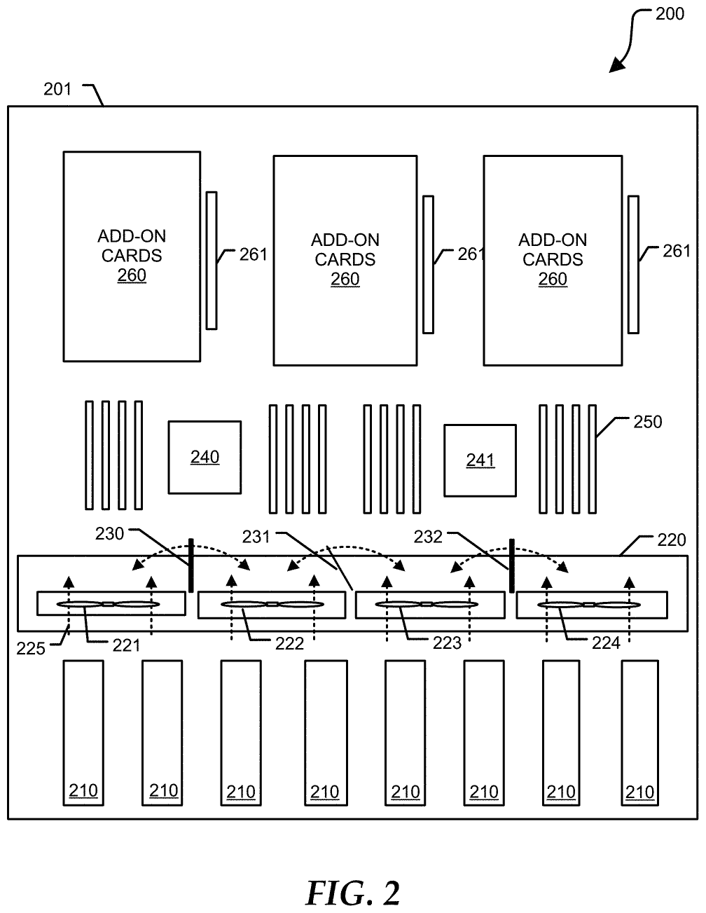

FIG. 2 shows an information handling system 200 according to another embodiment of the present disclosure. Information handling system 200 includes an enclosure 201, one or more hard disk drives 210, a fan bay 220 including one or more cooling fans 221, 222, 223, and 224, one or more central processing units 240 and 241, dual-inline-memory-modules (DIMMs) 250, and add-on cards 260 mounted at PCI riser slots 261. In an embodiment, fan bay 220 can include one or more articulated duct components (ADCs) 230, 231, and 232. Information handling system 200 can include additional components, not shown at FIG. 2 for clarity. During operation, cooling fans 221-224 generate airflow 225 through the system. CPUs 240, DIMMs 250, and other components may include an attached heatsink to help dissipate heat from the devices. Critical heat generating components including CPUs 240 and 241, DIMMs 250, and PCH 106 are generally arranged at a mainboard so that they are subject to a considerable portion of airflow 225 so that heat can best be extracted from these devices and expelled from enclosure 201. However, due to variations in computational workload and airflow restrictions caused by variations in system hardware configuration, airflow provided by a default fan and fixed ducting component configuration may not provide optimal cooling at any particular time. Accordingly, techniques disclosed herein provide real-time control of ADCs 230, 231, and 232 to modify the airflow within enclosure 201, directing a portion of airflow 225 to where it can be most effective.

During operation, BMC 180 can be configured to monitor the operating temperature, power consumption, and other parameters at selected system components, such as CPUs 240 and 241, and add-on cards 260. BMC 180 may further identify how system 200 is configured with regard to various components that can restrict or otherwise modify the circulation of airflow 225 within enclosure 201. In addition, BMC 180 can identify which card slots at PCI riser slots 261 are populated, and identify the type of add-on card included at each riser slot. For example, if particular riser slots are not populated with an add-on card, airflow 225 can be expected to favor the open areas, partially depriving the populated slots of needed airflow. In an embodiment, enclosure 210 can include one or more rigid air ducts configured to channel airflow 225 in a particular manner. However, it may not be cost effective to provide customized rigid air ducts for each and every configuration option. As disclosed herein, BMC can adjust an orientation or an angle of one or more of ADCs 230-232 to modify airflow 225. For example, ADC 231 is shown to be directing airflow from fans 222 and 223 to the left side of enclosure 201. Airflow provided by a fan typically includes a radial/outward component, and an ADC can interact with the resulting swirling airflow. Fans 221-224 may further include fixed exhaust vanes configured to modify the airflow provided by each fan, for example to provide a more laminar airflow.

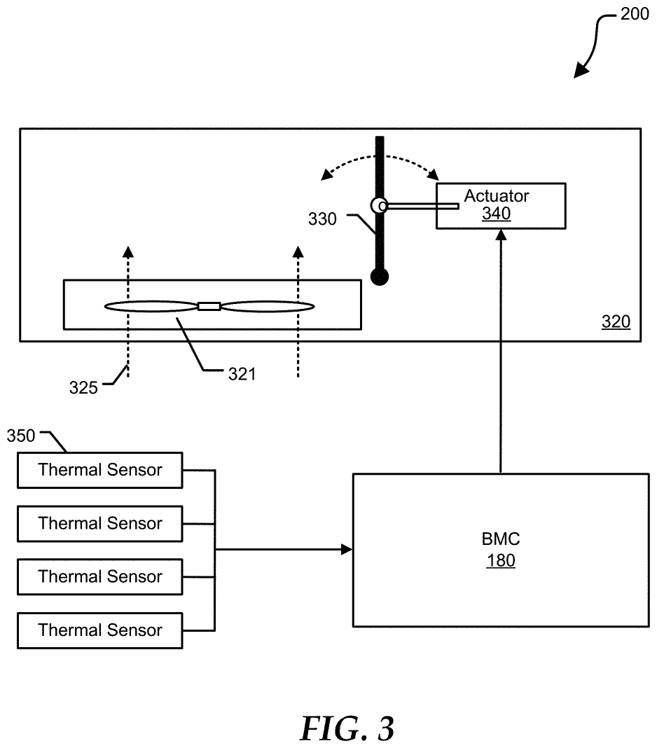

FIG. 3 shows operation of an ADC at information handling system 200 according to a specific embodiment of the present disclosure. In particular, FIG. 3 shows a fan bay 320 including a fan 321, an ADC 330, an actuator 340, and a reference 325 illustrating airflow. FIG. 3 further includes BMC 180 and thermal sensors 350. Actuator 340 can include a servo, a linear actuator, a piezoelectric or bimetallic bending element, or another type of electromechanical device operable to adjust the angle of ADC 330 in response to a signal provided by BMC 180. As used herein, the term articulated duct components can include any adjustable object that can modify or redistribute airflow. An ADC may synonymously be referred to as a vane, a louver, a damper, a baffle, and the like. An ADC typically includes a planar surface that can divert a portion of airflow generated by a fan or another device capable of moving air. The ADC is flexibly attached to a fan, a fixed air duct, or another chassis component at an information handling system using a hinge, bearing, a flexible polymer, and the like. ADC 330 is coupled to actuator 340 using any linkage capable of translating movement of actuator 340 or an angular adjustment of ADC 330. In an embodiment, ADC 330 can include a spring (not shown at FIG. 3) that can return ADC 330 to a default angle when not controlled directly by actuator 340.

During operation, BMC is configured to monitor parameters at system 200, such as temperature information provided by one or more thermal sensors 350 that are incorporated at selected system components, such as CPUs 240 and 241. For example, with reference to FIG. 2, BMC 180 can determine that the temperature at CPU 240 is higher than the temperature at CPU 241, the difference in temperature may be due to a difference is computational activity at each processor. In response, BMC 180 can command actuator 340 to adjust the angle of ADC 231 so as to divert a portion of airflow 225 towards CPU 240. If at a later time the temperature of CPU 241 is greater than the temperature of CPU 240, BMC 180 can reposition ADC 231 to instead divert airflow towards CPU 241. As disclosed herein, temperature is only one example of a system operating parameter that BMC 180 can utilize to determine how to configure ADC 330.

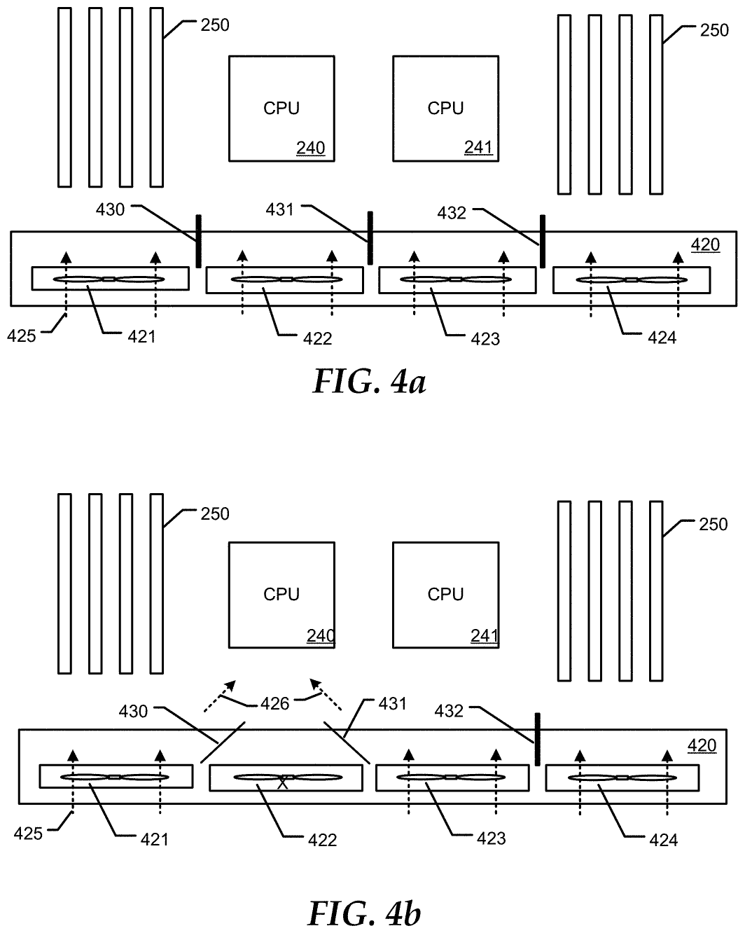

FIGS. 4a and 4b show control of articulated duct components according to a specific embodiment of the present disclosure. FIGS. 4a and 4b each illustrate CPUs 240 and 241, DIMMs 250, a fan bay 420 including fans 421, 422, 423, and 424, and ADCs 430, 431, and 432. At FIG. 4a, ADCs 430-432 are each configured to be perpendicular to the major surface of fan bay 420 so that airflow 425 from each fan is directed in the perpendicular direction, directly out from fan bay 420. At FIG. 4b, BMC 180 has determined that fan 422 has failed. As a result, CPU 240 may receive inadequate cooling. In response to identifying the failure of fan 422, BMC 180 can adjust the angle of ADC 430 and/or ADC 431 as shown at FIG. 4b so that a portion 426 of airflow 425 is diverted towards CPU 240.

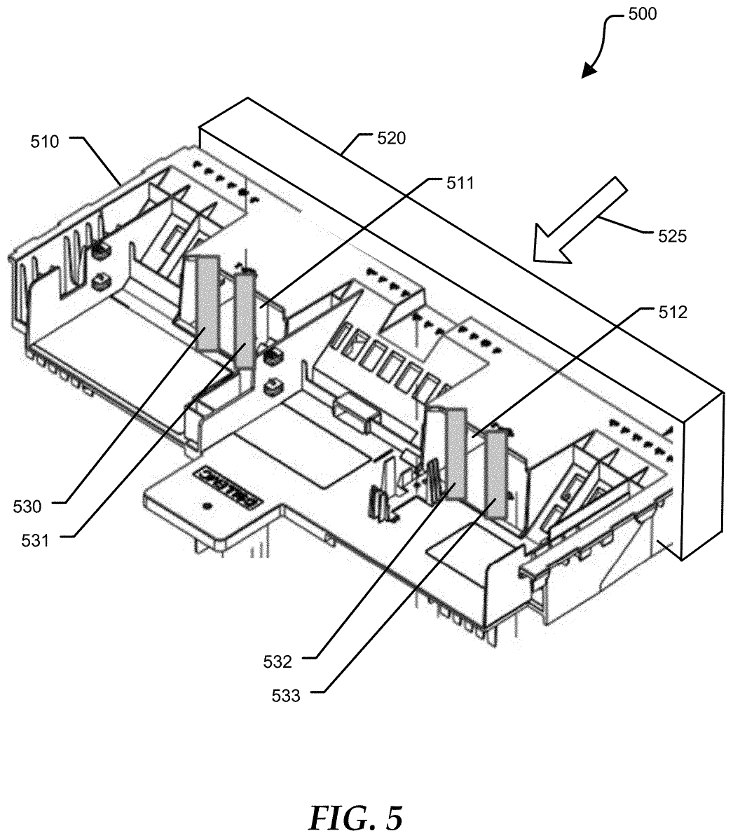

FIG. 5 shows how articulated duct components can be coupled to a fixed air duct according to a specific embodiment of the present disclosure. FIG. 5 illustrates an assembly 500 that includes a fixed air duct 510 and a fan bay 520 including one or more fans (not shown). Fixed air duct 510 can be configured to route airflow 525 provided by fans at fan bay 520 to specific system components, such as CPUs 240 and 241 and DIMMs 250 of FIG. 2. For example, fixed air duct 510 can be located above/surrounding CPUs 240 and 241, and DIMMS 250. Fixed air duct 510 can include a gasket (not shown) to seal duct 510 to portions of a main printed circuit board upon which the CPUs and DIMMs are mounted. Fixed air duct 510 includes opening, for example openings 511 and 512 to allow airflow 525 to exit duct 510 and continue to other portions of information handling system 200. Assembly 500 includes ADCs 530, 531, 532, and 533 that are configured to modify a direction of airflow exiting fixed air duct 510 via openings 511 and 512. For example, one or more actuators can control the angle of selected ADCs 530-533 to adjust how airflow exiting assembly 500 is diverted to other system components, for example to particular add-on cards 260. As described above, the angle of ADCs 530-533 can be adjusted using actuators under the control of BMC 180 to direct a portion of airflow 525 to selected system components.

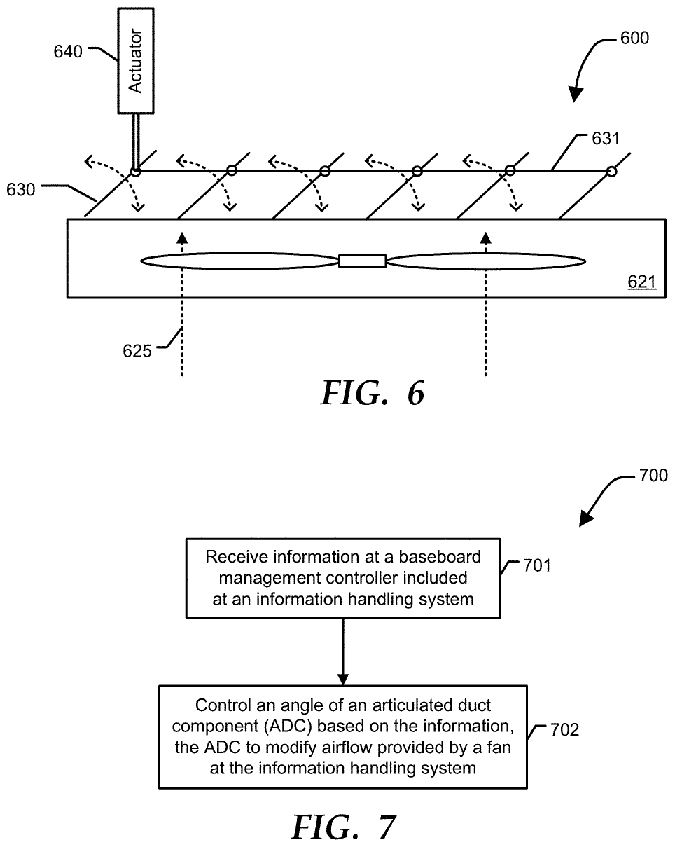

FIG. 6 shows the use of multiple articulated duct components to provide a louver 600 according to a specific embodiment of the present disclosure. Louver 600 includes two or more ADCs 630 that are coupled to move in unison by a linkage 631 in response to actuator 640. Louver 600 can be configured to direct airflow 625 as desired, or to substantially block all airflow from passing through the opening of fan 621. For example, louver 600 can be controlled to prevent recirculation of air back to a plenum area at the inlet side of fan 621 in the event that fan 621 is defective or otherwise deactivated.

FIG. 7 shows a method 700 for controlling an articulated duct component according to a specific embodiment of the present disclosure. Method 700 begins at block 701 where information is received at a baseboard management controller included at an information handling system. For example, BMC 180 can monitor the operating temperature of selected system components such as CPUs 240 and 241, in addition to other system operating parameters. Method 700 completes at block 702 where an angle of an articulated duct component is controlled based on the received information. As described above, an ADC can be configured to modify airflow provided by a fan at the information handling system to better utilize available airflow provided by cooling fans.

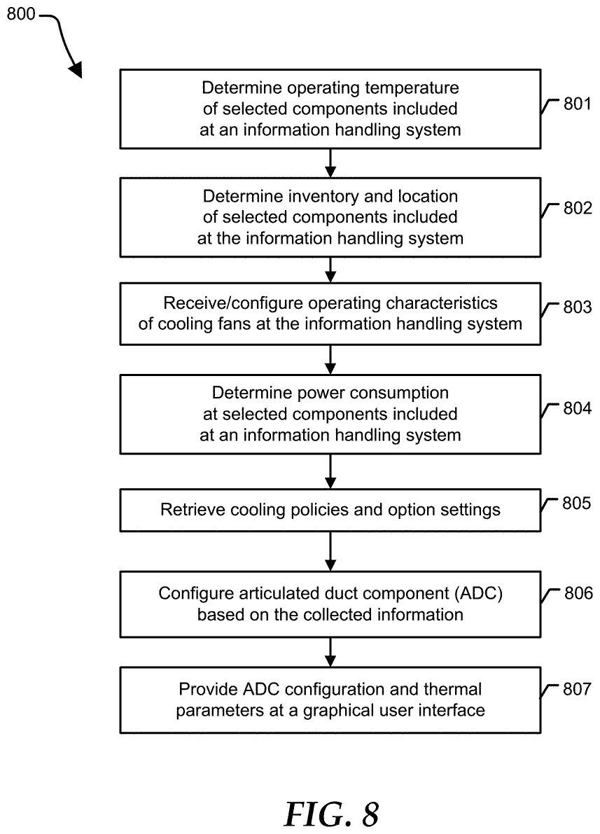

FIG. 8 shows a method 800 for controlling an articulated duct component according to a specific embodiment of the present disclosure. Method 800 begins at block 801 where an operating temperature of selected components included at an information handling system is determined. At block 802, an inventory and location of selected components included at the information handling system is determined. The inventory and location information can be used to identify how airflow provided by cooling fans may be impeded, as well as to identify particular devices and add-on cards that may require preferential cooling. At block 803, operating characteristics of cooling fans at the information handling system are received or configured. The operating characteristics can include a speed of each cooling fan, which fans are enabled or operational, whether a fan bay is fully populated with fans, and the like. At block 804, power consumption at selected components included at an information handling system is determined. Power consumption typically correlates with operating temperature, but may provide a better indication of a total amount of heat generated by a component than is provided by a discrete thermal sensor.

Method 800 continues at block 805 where a cooling policy and option settings are retrieved. The policy and settings can be provided by an original equipment manufacturer, a system administration technician, by automated control algorithms, or by other means. For example, a user may utilize a BIOS configuration interface or BMC interface to specify operational priorities, cooling system configuration information, and the like. At block 806, an articulated duct component is configured based on the collected information. For example, with reference to FIG. 2, BMC 180 can control an angle of ADCs 230-232 to modify how airflow 225 is distributed to particular system components. The information collected at blocks 801-805 are only examples of information that can be utilized by BMC 180 to identify an optimal configuration of selected ADCs. Accordingly, BMC 180 can utilize fewer factors, or additional factors, to make determine how to configure each ADC. Method 800 completes at block 807 where ADC configuration and thermal parameters are provided at a graphical user interface available for review by a system administration technician. In addition, the configuration and thermal parameters can be provided to automated or remote administration resources.

Referring back to FIG. 1, the information handling system 100 can include a set of instructions that can be executed to cause the information handling system to perform any one or more of the methods or computer based functions disclosed herein. The information handling system 100 may operate as a standalone device or may be connected to other computer systems or peripheral devices, such as by a network.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The information handling system 100 can include a disk drive unit and may include a computer-readable medium, not shown in FIG. 1, in which one or more sets of instructions, such as software, can be embedded. Further, the instructions may embody one or more of the methods or logic as described herein. In a particular embodiment, the instructions may reside completely, or at least partially, within system memory 104 or another memory included at system 100, and/or within the processor 102 during execution by the information handling system 100. The system memory 104 and the processor 102 also may include computer-readable media. A network interface device (not shown at FIG. 1) can provide connectivity to a network, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a first fan to generate airflow within the information handling system;
a first articulated duct component (ADC) to modify the airflow; and
a baseboard management controller (BMC) to selectively adjust an angle of the ADC based on first information received at the BMC.

2. The information handling system of claim 1, further comprising an actuator to adjust the orientation of the first ADC in response to signaling provided by the BMC.

3. The information handling system of claim 1, wherein the first information includes a temperature at a first component at the information handling system and a temperature at a second component at the information handling system.

4. The information handling system of claim 1, wherein the first information includes an inventory of components included at the information handling system and a location of a first component within information handling system enclosure.

5. The information handling system of claim 1, wherein the first information includes operating characteristics of the first fan and of one or more additional fans.

6. The information handling system of claim 1, wherein the first ADC is configured to reduce recirculation of airflow provided by the first fan to a plenum at an inlet side of the first fan.

7. The information handling system of claim 1, wherein the BMC adjusts the orientation of the first ADC to increase airflow proximate to a heat generating device.

8. The information handling system of claim 1, wherein the BMC is configured to adjust the orientation of the first ADC without user intervention.

9. The information handling system of claim 1, wherein the BMC provides a graphical user interface to facilitate monitoring and controlling of the first ADC.

10. The information handling system of claim 1, wherein the first ADC is incorporated at a fan bay, the fan bay including hardware for mounting the first fan.

11. The information handling system of claim 1, wherein the first ADC is incorporated at an output of a fixed air duct component, the first fan proximate to an input of the fixed air duct component.

12. The information handling system of claim 1, wherein the first ADC is coupled to a second ADC, an actuator configured to adjust the orientation of the first and second ADC in tandem.

13. A method comprising:
receiving first information at a baseboard management controller (BMC) included at an information handling system; and
controlling an angle of a first articulated duct component (ADC) based on the first information, the ADC to modify airflow provided by a first fan at the information handling system.

14. The method of claim 13, further comprising controlling the angle using an actuator, the actuator responsive to a command issued by the BMC.

15. The method of claim 13, wherein the first information includes a temperature at a first component at the information handling system and a temperature at a second component at the information handling system.

16. The method of claim 13, wherein the first information includes an inventory of components included at the information handling system and a location of a first component within information handling system enclosure.

17. The method of claim 13, wherein the first ADC is configured to reduce recirculation of airflow provided by the first fan to a plenum at an inlet side of the first fan.

18. The method of claim 13, wherein the first ADC is incorporated at a fan bay, the fan bay including hardware for mounting the first fan.

19. The method of claim 13, wherein the first ADC is incorporated at an output of a fixed air duct component, the first fan proximate to an input of the fixed air duct component.

20. A baseboard management controller comprising:
an input to receive first information indicating operating status and configuration of components included at an information handling system; and
an output to provide a signal to an actuator, the actuator coupled to a first articulated duct component (ADC), the first ADC to modify airflow provided by a first fan.
